(19) United States
(12) Patent Application Publication
(10) Pub. No.: US 2025/0382002 A1
(43) Pub. Date: Dec. 18, 2025

(54) A SEAT FOR A BUGGY, STROLLER OR PUSHCHAIR

(71) Applicant: Milk Holding B.V., Amsterdam (NL)

(72) Inventors: Aran ALAEI, Amsterdam (NL); Michel Paul René HOLPER-BOS, Amsterdam (NL); Martijn Henri Johan CLAESSEN, Amsterdam (NL)

(73) Assignee: Milk Holding B.V., Amsterdam (NL)

(21) Appl. No.: 19/141,974

(22) PCT Filed: Dec. 20, 2023
(86) PCT No.: PCT/NL2023/050674

§ 371 Date: Jun. 20, 2025

(30) Foreign Application Priority Data
Dec. 21, 2022 (NL) 2033787

(51) Int. Cl. B62B 9/10; B62B 9/14

(52) U.S. Cl. CPC B62B 9/104; B62B 9/14

(57) ABSTRACT

The invention relates to a seat for a buggy, stroller or pushchair. The seat comprises a seat unit, including a seat portion and a backrest portion. The seat also has a legrest portion and a profile structure connected to the backrest portion and the legrest portion. The profile structure includes a base portion and a top portion that are movable relative to each other. Upon moving the base portion and the top portion of the profile structure away from each other, the backrest portion and the legrest portion align relative to the seat portion.

The invention relates to a seat for a buggy, stroller or pushchair, comprising a seat unit, including a seat portion having a front side and a back side, and a backrest portion extending from the seat portion, the back rest portion having a top side and a bottom side, the backrest portion being pivotable relative to the seat portion around a pivoting axis close to or at the back side of the seat portion, and a profile structure carrying the seat unit.

Seats for buggies, strollers and pushchairs are generally known for comfortably carrying young children. The seats typically have a seat portion and a backrest portion that is hingeable relative to the seat portion so as to enable the seat to be alter from a so-called reclined state wherein the seat portion and the backrest portion are flat, to a so-called upright state wherein the backrest portion has an angle relative to the seat portion, and vice versa. In the upright state, a child may sit in the seat, while in the reclined state, the child may rest or sleep. The profile carries the seat unit, and may be supported by a buggy, stroller or pushchair.

It appears, in practice, that users of the seat have to carry out a number of acts to modify the seat from the reclined state into the upright state, and vice versa.

It is an object of the present invention to provide a seat that can easily be modified from the reclined state into the upright state, and vice versa. Thereto, according to an aspect of the invention, a seat is provided including a seat portion having a front side and a back side, and a backrest portion extending from the seat portion, the back rest portion having a top side and a bottom side, the backrest portion further being pivotable relative to the seat portion around a pivoting axis close to or at the back side of the seat portion, a legrest portion extending from the seat portion, the legrest portion having a top side and a bottom side, the legrest portion further being pivotable relative to the seat portion around a pivoting axis close to or at the front side of the seat portion, and a profile structure including a base portion and a top portion that are movable relative to each other, wherein the top portion of the profile structure is associated with the top side of the backrest portion, and wherein the base portion of the profile structure is associated with the legrest portion, such that upon moving the base portion and the top portion of the profile structure away from each other, the backrest portion and the legrest portion align relative to the seat portion.

By providing a profile structure including a base portion and a top portion that are movable relative to each other, wherein the top portion of the profile structure is associated with the top side of the backrest portion and wherein the base portion of the profile structure is associated with the legrest portion, a step of aligning the backrest portion relative to the seat portion, i.e. bringing the seat into the reclining state, the base portion and the top portion of the profile structure move away from each other. Then, in a single step, the process of realizing the reclined state is performed. Further, by providing a legrest portion that is associated with the base portion of the profile structure, the step of aligning the backrest portion relative to the seat portion also aligns the legrest portion with the seat portion, arriving at a fully reclined state wherein the backrest portion, the seat portion and the legrest portion are more or less aligned with each other. Similarly, the step of bringing the seat into the upright state can be performed in a single step, viz. such that the base portion and the top portion of the profile structure move towards each other.

Advantageously, the base portion and the top portion of the profile structure are movable relative to each other along a one-dimensional path, in particular along a mainly linear one-dimensional path, e.g. by enabling a telescopic movement.

In a preferred embodiment, the seat unit includes a connecting arm having a first end that is pivotably connected to the back side of the seat portion or to the bottom side of the backrest portion, and a second end that is pivotably connected to the top portion of the profile structure, such that the step of bringing the seat into the upright state or the reclined state can be performed in a stable, reliable manner. In an alternative embodiment, the top portion of the profile structure is pivotably mounted to the top side of the backrest portion. In both embodiments, the top portion of the legrest portion can be pivotably mounted to the front side of the seat portion.

The invention also relates to a buggy, stroller or pushchair, comprising a supporting structure and a seat as described above wherein the profile structure is mounted to said supporting structure.

Further advantageous embodiments according to the invention are described in the following claims.

It should be noted that the technical features described above or below may each on its own be embodied in a seat, i.e. isolated from the context in which it is described, separate from other features, or in combination with only a number of the other features described in the context in which it is disclosed. Each of these features may further be combined with any other feature disclosed, in any combination.

The invention will now be further elucidated on the basis of a number of exemplary embodiments and an accompanying drawing. In the drawing:

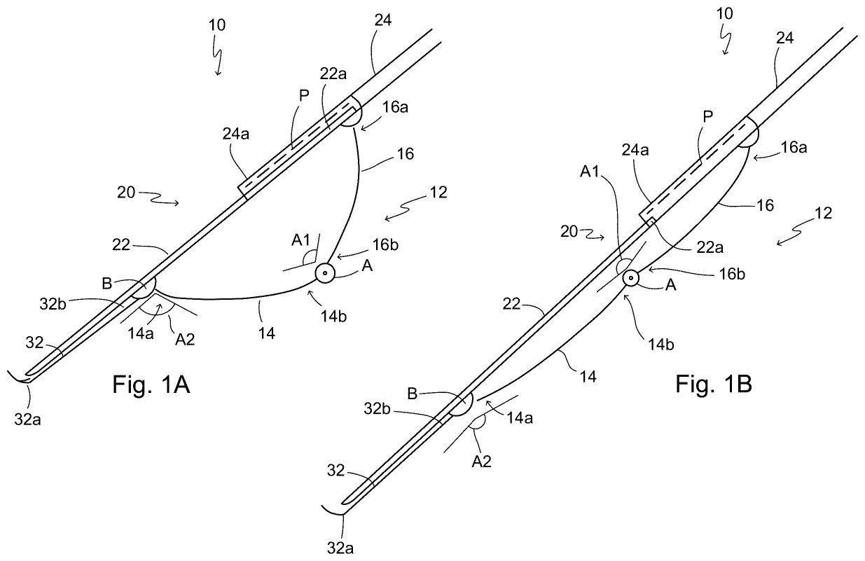

FIG. 1A shows a schematic side view of a seat according to a first embodiment of the invention, in a retracted position;

FIG. 1B shows a schematic side view of the seat of FIG. 1A, in an extended position;

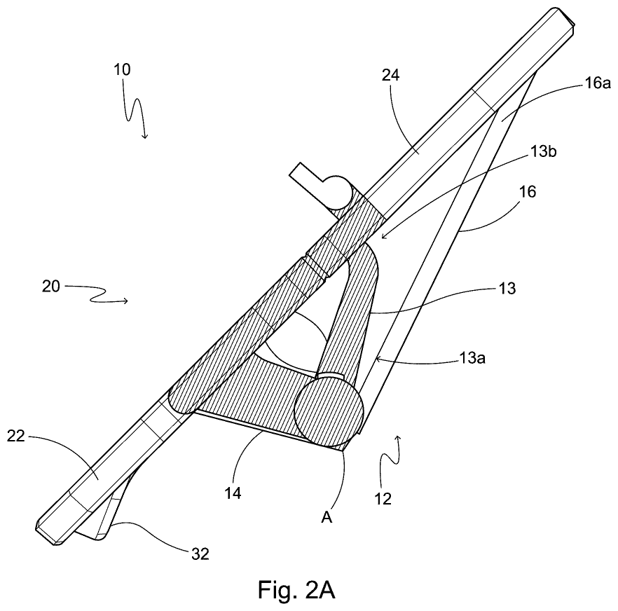

FIG. 2A shows a schematic side view of a seat according to a second embodiment of the invention, in a retracted position;

FIG. 2B shows a schematic side view of the seat of FIG. 2A, in an extended position;

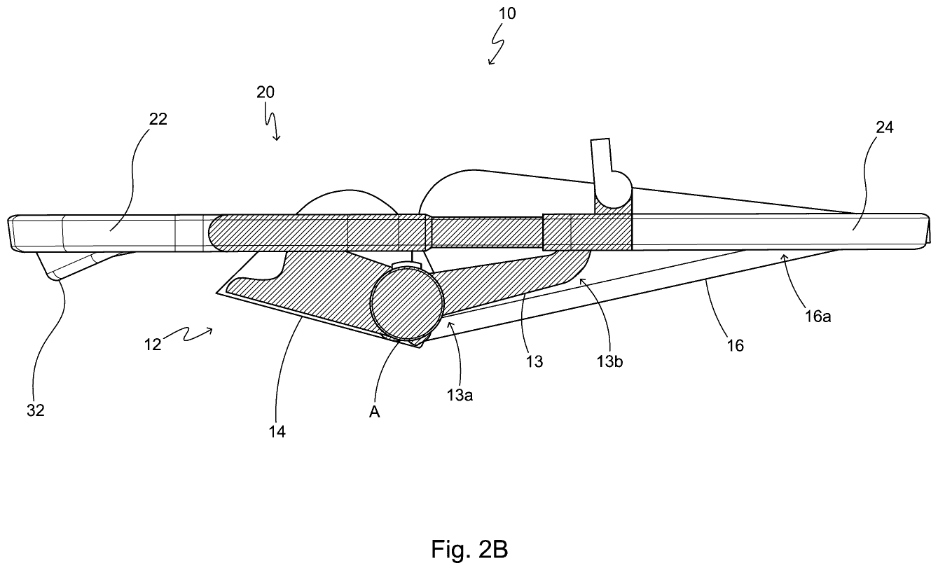

FIG. 3 shows a schematic perspective front view of a buggy having a seat as shown in FIG. 2;

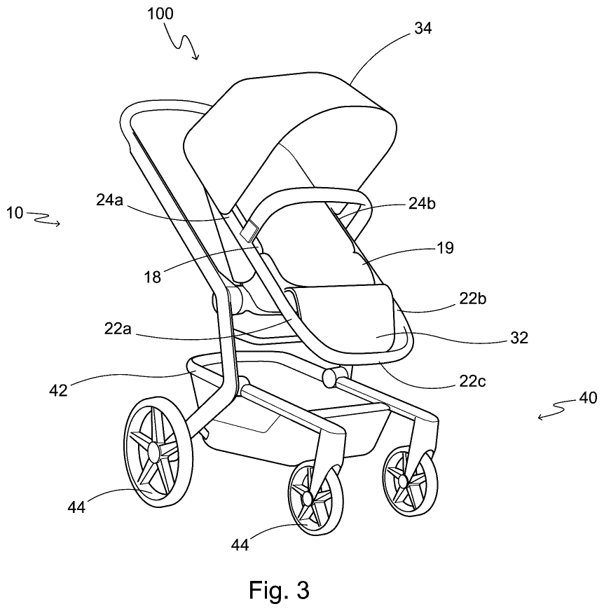

FIG. 4 shows a schematic perspective front view of a seat according to a third embodiment of the invention, in a retracted position, and

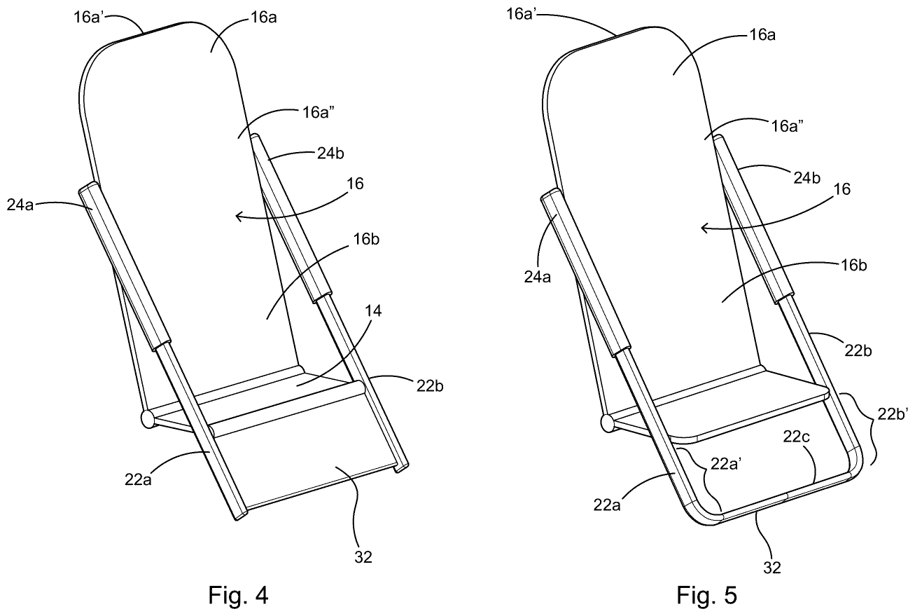

FIG. 5 shows a schematic perspective front view of a seat according to a fourth embodiment of the invention, in a retracted position.

It is noted that the figures show merely preferred embodiments according to the invention. In the figures, the same reference numbers refer to equal or corresponding parts.

FIGS. 1A and 1B show schematic side views of a seat 10 according to a first embodiment of the invention, for use in a buggy, stroller or pushchair.

The seat 10 has a seat unit 12 including a seat portion 14 and a backrest portion 16. The seat portion 14 has a front side 14a and a back side 14b. The backrest portion 16 has a top side 16a and a bottom side 16b. The backrest portion 16 is pivotable relative to the seat portion 14 around a pivoting axis A close to or at the back side 14b of the seat portion 14. In the shown embodiment, the seat portion 14 and the backrest portion 16 are hingeably connected.

The seat 10 also has a legrest portion 32 extending from the seat portion 14 and being mainly stationary relative to the base portion 22 of the profile structure 20, also during a process wherein the seat unit 12 is folded in or folded out. The legrest portion 32 has a top side 32a and a bottom side 32b and is pivotable relative to the seat portion around a pivoting axis close to or at the front side 14a of the seat portion 14.

The seat 10 also has a profile structure 20 connected to the seat unit 12. The profile structure 20 has a base portion 22 and a top portion 24 that are movable relative to each other. The top portion 24 of the profile structure 20 is associated with the top side 16a of the backrest portion 16 and the base portion 22 of the profile structure 20 is associated with the legrest portion 32, e.g. via the bottom side 32b of the legrest portion 32.

The base portion 22 and the top portion 24 of the profile structure 20 are movable between a retracted position as shown in FIG. 1A and an extended position as shown in FIG. 1B. In the retracted position, the seat unit 12 is in an upright state wherein the backrest portion 16 is mainly transverse to the seat portion 14, ready for carrying a child in a sitting position. On the other hand, in the extended position, the seat unit 12 is in a reclined state wherein the seat unit is mainly flat, ready for carrying a child that is sleeping or resting, in a lying position.

A first angle A1 between the seat portion 14 and the backrest portion 16 ranges between circa 90° and circa 175°, in particular between circa 110° and circa 170°. As an example, in the upright state, the first angle is circa 110°, while, in the reclined state, the first angle is circa 170°.

Here, a second angle A2 between the seat portion and the legrest portion ranges between circa 90° and circa 175°, in particular between circa 110° and circa 170°. As an example, in the upright state, the first angle is circa 110°, while, in the reclined state, the first angle is circa 170°.

FIG. 2A shows a schematic side view of a seat according to a second embodiment of the invention, in a retracted position. Similarly, FIG. 2B shows a schematic side view of the seat of FIG. 2A, in an extended position.

FIG. 3 shows a schematic perspective front view of buggy 100 having a seat 10 as shown in FIG. 2.

According to an aspect of the invention, upon moving the base portion 22 and the top portion 24 of the profile structure 20 away from each other, towards the extended position the backrest portion 16 aligns relative to the seat portion 14. The seat unit 12 folds out. Similarly, upon moving the base portion 22 and the top portion 24 of the profile structure 20 towards each other, towards the retracted position, the seat unit 12 folds in. Thus, in use, upon bringing the seat unit 12 into the reclined state, the profile structure 20 extends, while, upon bringing the seat unit 12 into the upright state, the profile structure 20 retracts or collapses.

The shown seat 10 facilitates a process of bringing the seat unit 12 into the upright state or reclined state in a single movement, without separate position or orientation adjustment of the seat portion 14 relative to the backrest portion 16.

In the process of extending the base portion 22 and the top portion 24 of the profile structure 20 away from each other, also the legrest portion 32 aligns relative to the seat portion 14. Then, the backrest portion 16, the seat portion 14 and the legrest portion 32 are mainly aligned relative to each other, forming a more or less flat, reclined contour.

In the shown embodiments, the back side 14b of the seat portion 14 is pivotably mounted to the bottom side 16b of the backrest portion 16, so as to enable a folding movement of the seat portion 14 relative to the backrest portion 16 around the pivoting axis A. The seat portion 14 and the back portion 16 of the seat unit 12 may form an integrated part, e.g. being interconnected via a hinge portion. Alternatively, the seat unit 12 may be provided with a subframe mounted to the seat portion 14 and the back portion 16, the subframe including a pivoting structure enabling the seat portion 14 and the back portion 16 to pivot relative to each other.

In the embodiment shown in FIGS. 1A and 1B, the base portion 22 and the top portion 24 of the profile structure 20 are movable relative to each other along a one-dimensional linear path P. The base portion 22 and the top portion 24 are slidably mounted to each other via mainly straight respective free arm ends 22a, 24a, forming a telescopic connection. It is noted that, in an alternative implementation, the linear path P may be non-linear, e.g. having a curved section, e.g. wherein the free arm ends 22a, 24 are slightly curved.

In the embodiment shown in FIGS. 1A and 1B, the top portion 24 of the profile structure 20 is pivotably mounted to the top side 16a of the backrest portion 16 and the seat portion 14 is pivotably mounted to the top side 32a of the legrest portion 32, enabling the backrest portion 16 and the seat portion 14 to pivot relative to the profile structure 20 when the profile structure 20 retracts or extends.

In the embodiment shown in FIG. 3, the base portion 22 and the top portion 24 of the profile structure 20 each include two frame elements 22a,b; 24a,b, one at either side 18, 19 of the seat unit 12, thus having the seat unit 12 therebetween. The base portion 22 and the top portion 24 each further include transverse oriented frame elements 22c; 24c forming with the other two frame elements 22a,b; 24a,b an U-shaped structure. The transverse oriented frame elements 22c; 24c typically run at a bottom side and a top side, respectively, of the seat unit 12. The U-shaped structures form together an integral closed loop supporting the seat unit 12. The three frame elements 22a,b,c of the base portion 22 may be interconnected to each other for forming the U-shaped structure. Alternatively, the base portion 22 includes a single frame element having the above described U-shaped structure. Similarly, the top portion 24 may include a single integrally formed frame element or multiple frame elements forming the U-shaped structure. It is noted that, in another structure, only the base portion or only the top portion forms or has an U-shaped structure. Also, both the base portion and the top portion may be formed without an U-shaped structure, e.g. as two separate elongate profile elements. In this respect it is noted that the base portion 22 and the top portion 24 of the profile structure 20 may each have a single frame element, e.g. at the right side 18 or the left side 19 of the seat unit 12.

In the embodiment shown in FIGS. 1A and 1B, the top portion 24 of the profile structure 20 is pivotably mounted to the top side 16a of the backrest portion 16.

In the embodiment shown in FIG. 2, the seat unit 12 includes a connecting arm 13 having a first end 13a that is pivotably connected to the back side 14b of the seat portion 14 or to the bottom side 16b of the backrest portion 16, near or at the pivoting axis A, and a second end 13b that is pivotably connected to the top portion 24 of the profile structure 20.

In the embodiments shown in FIG. 1A, 1B and 2, the base portion 22 of the profile structure 20 is mounted to the bottom side 32b of the legrest 32, while the top side 32a of the legrest 32 is pivotably mounted to the front side 14a of the seat portion 14.

In an alternative embodiment, the seat unit 12 includes a subframe having subframe elements, such as a hingeable arm structure, running along side parts 18, 19 of the seat portion 14 and the backrest portion 16, respectively, and being pivotably mounted, e.g. at the ends of the hingeable arm structure, to the legrest top portion 32A and the top portion 24 of the profile structure 20, respectively.

Also in the embodiment shown in FIGS. 2A, 2B and 3 the seat 10 further has a leg rest portion 32 extending from the seat unit 12, in particular wherein the leg rest portion 32 is mainly stationary relative to the profile structure 20, also during a process wherein the seat unit 12 is folded in or folded out.

Optionally, the seat unit 12 is removably mounted to the profile structure 20. Then, the seat unit 12 can be disassembled from the profile structure 20 if desired, and assembled to the profile structure 20 if desired.

In the embodiment show in FIGS. 2A, 2B and 3, the seat 10 is provided with a canopy 34. In another embodiment, the seat 10 may be implemented without a canopy.

The buggy shown in FIG. 3 comprises a supporting structure 40 and a seat 10 as described above referring to FIGS. 2A and 2B. The supporting structure 40 has a frame 42 and wheels 44. Here, the profile structure 20 of the seat 10 is mounted to the supporting structure 40, e.g. via a hingeable connection.

FIG. 4 shows a schematic perspective front view of a seat 10 according to a third embodiment of the invention, in a retracted position, and FIG. 5 shows a schematic perspective front view of a seat according to a fourth embodiment of the invention, in a retracted position. In FIG. 5, the legrest portion 32 includes the transverse oriented frame element 22c and adjacent, curved end sections 22a′, 22b′ of the two opposite frame elements 22a,b of the profile structure base portion 22.

Contrary to the first embodiment shown in FIG. 1A and 1B and the second embodiment shown in FIG. 2A and 2B wherein the top portion of the profile structure is associated with an upper part or edge 16a′ of the top side 16a of the backrest portion 16, the seat 10 according to the third embodiment shown in FIG. 4 and the fourth embodiment shown in FIG. 5, has a profile structure top portion that is associated with another part 16a″ of the top side 16a of the backrest portion 16, slightly lower, offset from the upper part or edge 16a′ of the backrest portion top side 16a.

The invention is not restricted to the embodiments described above. It will be understood that many variants are possible.

It is noted that, in principle, the backrest structure can be

These and other embodiments will be apparent for the person skilled in the art and are considered to fall within the scope of the invention as defined in the following claims. For the purpose of clarity and a concise description features are described herein as part of the same or separate embodiments. However, it will be appreciated that the scope of the invention may include embodiments having combinations of all or some of the features described.

1. A seat for a buggy, stroller or pushchair, comprising:
a seat unit, including a seat portion having a front side and a back side, and a backrest portion extending from the seat portion, the back rest portion having a top side and a bottom side, the backrest portion further being pivotable relative to the seat portion around a pivoting axis close to or at the back side of the seat portion;
a legrest portion extending from the seat portion, the legrest portion having a top side and a bottom side, the legrest portion further being pivotable relative to the seat portion around a pivoting axis close to or at the front side of the seat portion, and
a profile structure including a base portion and a top portion that are movable relative to each other, wherein the top portion of the profile structure is associated with the top side of the backrest portion, and wherein the base portion of the profile structure is associated with the legrest portion, such that upon moving the base portion and the top portion of the profile structure away from each other, the backrest portion and the legrest portion align relative to the seat portion.

2. A seat according to claim 1, wherein the legrest portion is mainly stationary relative to the base portion of the profile structure.

3. A seat according to claim 1 or 2, wherein the base portion and the top portion of the profile structure are movable relative to each other between a retracted position corresponding to an upright state of the seat unit, and an extended position corresponding to a reclined state of the seat unit.

4. A seat according to claim 3, wherein, in the upright state of the seat unit, the backrest portion is mainly transverse to the seat portion.

5. A seat according to claim 3 or 4, wherein, in the reclined state, the seat unit is mainly flat.

6. A seat according to any of the preceding claims, wherein an angle between the seat portion and the backrest portion ranges between circa 90° and circa 175°, in particular between circa 110° and circa 170°.

7. A seat according to any of the preceding claims, wherein an angle between the seat portion and the legrest portion ranges between circa 90° and circa 175°, in particular between circa 110° and circa 170°.

8. A seat according to any of the preceding claims, wherein the back side of the seat portion is pivotably mounted to the bottom side of the backrest portion.

9. A seat according to any of the preceding claims, wherein the base portion and the top portion of the profile structure are movable relative to each other along a mainly linear one-dimensional path.

10. A seat according to any of the preceding claims, wherein the seat unit includes a connecting arm having a first end that is pivotably connected to the back side of the seat portion or to the bottom side of the backrest portion, and a second end that is pivotably connected to the top portion of the profile structure.

11. A seat according to any of the preceding claims, wherein the top portion of the profile structure is pivotably mounted to the top side of the backrest portion.

12. A seat according to any of the preceding claims, wherein the base portion of the profile structure is also associated with the top side of the legrest portion.

13. A seat according to any of the preceding claims, wherein the base portion and the top portion of the profile structure each include two frame elements carrying the seat unit therebetween.

14. A seat according to any of the preceding claims, wherein the frame elements of the base portion and/or the top portion form an U-shaped structure.

15. A seat according to any of the preceding claims, wherein the base portion and the top portion are slidably mounted to each other via respective free arm ends.

16. A seat according to any of the preceding claims, wherein the seat unit is removably mounted to the profile structure.

17. A seat according to any of the preceding claims, further comprising a canopy mounted to the profile structure.

18. A seat according to any of the preceding claims 9-17, wherein the base portion and the top portion of the profile structure are arranged to be movable relative to each other along a mainly linear one-dimensional path in a telescopic movement.

19. A buggy, stroller or pushchair, comprising a supporting structure and a seat according to any of the preceding claims, wherein the profile structure of the seat is mounted to the supporting structure.
